(19) United States
(12) Patent Application Publication
(10) Pub. No.: US 2006/0249093 A1
(43) Pub. Date: Nov. 9, 2006

(54) Animal shelter

(76) Inventors: Kevin Fuksa, Hennessey, OK (US); Traci Fuksa, Hennessey, OK (US)

Correspondence Address: DUNLAP, CODDING & ROGERS P.C., PO BOX 16370, OKLAHOMA CITY, OK, 73113, US

(21) Appl. No.: 11/409,248

(22) Filed: Apr. 21, 2006

Related U.S. Application Data
(60) Provisional application No. 60/673,481, filed on Apr. 21, 2005.

(51) Int. Cl. A01K 1/03

(52) U.S. Cl. 119/482

(57) ABSTRACT

An animal shelter includes a housing, a heating compartment, a cooling device and a control device. The housing defines a shelter cavity therein. The shelter cavity is sized to accommodate one or more animals. The housing has an opening therein permitting ingress and egress from the shelter cavity of the housing. The heating compartment is positioned within a portion of the housing so as to provide unrestricted access to the shelter cavity. The heating compartment is sized and dimensioned to accommodate at least one heating element for heating the shelter cavity. The cooling device is positioned within a portion of the housing for cooling the shelter cavity. The control device is operably connected to the at least one heating element and the cooling device for selectively activating the at least one heating element or cooling device to provide a thermally controlled environment within the shelter cavity.

### CROSS REFERENCE TO RELATED APPLICATIONS

The present patent application claims priority to the provisional patent application identified by U.S. Ser. No. 60/673,481, filed Apr. 21, 2005, entitled “Animal Shelter”.

### BACKGROUND OF THE INVENTION

1. Field of the Invention

The present invention relates generally to an animal shelter, and more particularly, not by way of limitation, to an improved animal shelter capable of controlling the temperature inside the animal shelter.

2. Brief Description of the Related Art

A wide variety of outdoor shelters for housing and protecting domesticated animals, such as dogs, cats, or the like, against inclement weather conditions have been developed. Many domesticated animal shelters have been designed and marketed for animals that spend most of their lives outside. Existing animal shelters are primarily designed so as to simply shield the animal against direct exposure to the external environment but afford little, if any, protection toward providing a regulated and desirable habitat for the sheltered animal, especially when weather conditions result in extremely cold temperatures.

Heating devices have been developed for keeping animals warm, but these have focused on indoor pets. Incubators, indoor beds, heating pads and the like have been developed, but are principally intended for indoor use and would provide minimal protection if used outdoors.

Various problems currently associated with the inability to regulate and control the habitat for sheltered domesticated animals is aptly illustrated by owners of hunting dogs. Hunting dogs in the late fall and early winter months are often fielded from dawn to dusk during which time the hunting dogs expend considerable energy and become extremely dirty in the performance of exhaustive hunting tasks for their owners. The dog's general uncleanliness prevents the owner from temporarily sheltering the dog within the owner's living quarters. Consequently, upon return from the hunt, such hunting dogs are normally fed and sheltered outside. This common practice adversely affects both the general health and hunting life of the dog. The failure to promptly house animals within a warm shelter for a sufficient period of time to revitalize and stabilize the animal's system seriously impairs the animal's resistance against disabling diseases and aging infirmities. An outdoor shelter capable of providing a comfortable and warm habitat for a domesticated animal under such inclement weather conditions could significantly extend a dog's productive hunting life.

To this end, a need exists for an improved animal shelter which would more effectively protect the animal against inclement weather conditions by providing a shelter which controls the temperature inside the shelter. It is to such an animal shelter that the present invention is directed.

### BRIEF DESCRIPTION OF THE SEVERAL VIEWS OF THE DRAWINGS

FIG. 1 is an elevational view of an animal shelter constructed in accordance with the present invention.

FIG. 2 is a cross-sectional view of the animal shelter of FIG. 1.

FIG. 3 is a top view of the animal shelter roof of FIG. 1.

### DETAILED DESCRIPTION OF THE INVENTION

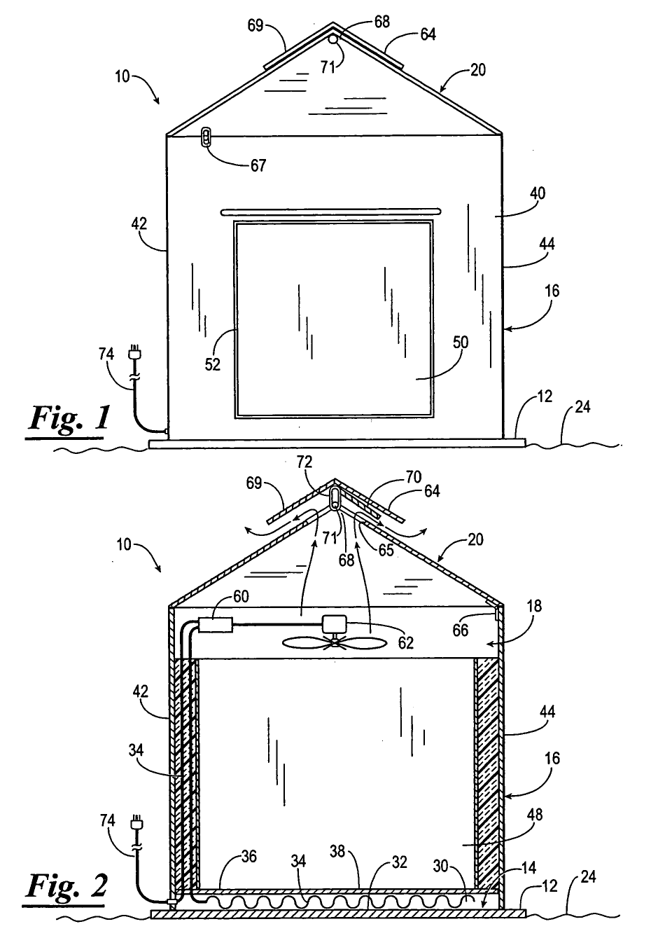

Referring now to the drawings, and more particularly to FIGS. 1 and 2, an animal shelter 10 constructed in accordance with the present invention is shown. The animal shelter 10 is preferably constructed of a polymeric material. The animal shelter 10 is formed from one solid piece of material, however, it should be understood that the animal shelter 10 may be constructed from various components. The animal shelter 10 is preferably made of a durable and rigid material which is strong enough to prevent damage to the animal shelter 10. Forming the animal shelter 10 of a polymeric material provides a waterproof shelter which is easy to transport and install. However, it should be understood that the animal shelter 10 can be constructed from a variety of materials and can be formed of multiple components.

The animal shelter 10 includes a base member 12, a heating compartment 14, a housing 16, a temperature control compartment 18, a roof 20 and a power source 22. The base member 12 of the animal shelter 10 is disposed on the ground 24. The base member 12 is constructed from a pre-molded, rigid polymeric material. The base member 12 provides a stable support surface for the housing 16. The base member 12 may be adapted to allow an owner to anchor the animal shelter 10 to the ground 24 with bolts, stakes, or the like. However, it should be understood that other anchoring devices may be used in accordance with the present invention. Further, it should be understood that though the ground 24 is shown supporting the base member 12 of the animal shelter 10, any suitable mounting surface or any suitable mounting surface of a vehicle, such as a truck bed, a trailer, or the like, may be used to secure and transport the animal shelter 10 in accordance with the present invention.

The heating compartment 14 is provided with a housing 30 that defines a retaining space 32 sized and dimensioned to accommodate heating elements 34. The heating compartment 14 is positioned within the housing 16 and about the shelter cavity 48 so as to provide unrestricted access to the shelter cavity 48. The heating elements 34 are insulated, low-voltage wires and are positioned within the retaining space 32. However, it should be understood that the heating element may be any device known in the art to provide heat to the shelter cavity in accordance with the present invention. The heating elements 34 are disposed about posts or other anchoring devices. However, it should be understood that the heating elements 34 may be disposed in the retaining space 32 of the housing 30 of the heating compartment 14 by any known method in accordance with the present invention. Fire retardant material is provided in the retaining space 32, if needed. A cover 36 is positioned over the retaining space 32 of the heating compartment 14. The cover 36 is securely fixed in position and is adapted to conform with the housing 30 of the heating compartment 14 so as to provide a suitably rigid structure. The cover 36 includes an animal heating surface 38.

The housing 16 is shown herein to have a substantially rectangular shape. However, it will be appreciated that the housing 16 may be constructed in a variety of different shapes so long as the animal shelter 10 can accommodate at least one animal. More specifically, the housing 16 has a front wall 40, a rear wall (not shown), a first side wall 44, and a second side wall 46 extending from the heating compartment 14 and cooperating with the heating compartment 14 to define a shelter cavity 48. The front wall 40, rear wall, first sidewall 42, and second sidewall 44 are connected to the heating compartment 14 in a conventional manner to provide structural integrity. Preferably, the walls are insulated with Kevlar®, however, the four wails of the housing 16 may be insulated, for example, with Styrofoam®, or any other such insulation material such as foamed polymeric, fiber glass, blown insulation, or the like.

The front wall 40 is provided with an opening 50 which is in open communication with the shelter cavity 48 to permit an ingress to and egress from the shelter cavity 48 of the housing 16. Preferably, a door 52 is mounted to the front wall 40 of the housing 16 with a hinge so as to cover the opening 50. It should be understood that though the door 52 is shown connected to the housing 16 by a hinge, any known connector to connect the door 52 to the housing 16 may be used. The door 52 is made of a durable hard plastic and can swing open for easy access for the animal. It should be understood that the door 52 may be constructed from any variety of materials and be constructed in any shape. The door 52 closes automatically once the animal has entered the shelter cavity 48. Some air will be allowed between the door 52 and the opening 50. The door 52 may be kept closed during the colder months so that heat stays inside the housing 16. When the weather turns primarily hot, the door 52 may be adapted to be turned over and left open for optimum air flow. A portion of the door 52 may be constructed from a transparent material allowing the animal to see outside the animal shelter 10 when positioned inside the shelter cavity 48. It should be understood that the animal shelter 10 may be provided with a window or some other type of opening in one of the walls or the roof of the animal shelter 10 so the animal may see outside when positioned inside the shelter cavity 48.

The animal heating surface 38 of the heating compartment 14 may be positioned horizontally to act as a floor for the shelter cavity 48 of the housing 16 between the front wall 40, rear wall, first sidewall 42 and second sidewall 44. The heating compartment 14 may also be positioned vertically within or in proximity to the front wall 40, rear wall, first sidewall 42, and second sidewall 44 so that heat may be conducted from the walls as well as the floor to heat the shelter cavity 48. It should be understood that the heating compartment 14 may be formed as a single piece or multiple components. Upon activation, the heating compartment 14 provides a controlled heat to the shelter cavity 48 of the housing 16.

The temperature control compartment 18 includes a thermostat 60 and a fan 62. The temperature control compartment 18 is positioned within a portion of the housing 16 so as to provide unrestricted access to the shelter cavity 48. The temperature control compartment 18 can be positioned to separate the housing 16 and the roof 20. Preferably, the thermostat 60 and the fan 62 are mounted on the top of the housing 16 in the temperature control compartment 18. It should be understood that any thermostat or control device known in the art, such as a conventional household or industrial thermostat may be used for controlling the temperature within the shelter cavity 48 in accordance with the present invention. Preferably, the fan 62 is a high-speed, thermostatically controlled metal fan. However, it should be understood that any fan or other cooling device known in the art may be used in accordance with the present invention, such as a blower or refrigeration unit. A grilled cage (not shown) may be constructed about the temperature control compartment 18. The grilled cage prevents damage to the thermostat 60 and the fan 62 by the animal as well as injury to the animal. The grilled cage may be constructed from metal, polymeric materials, or the like. One end of the grilled cage may be hinged and capable of latching at another end allowing a user access to the thermostat 60 and the fan 62 for repair or replacement.

The thermostat 60 is operably connected to the heating elements 34 and the fan 62. The thermostat 60 is programmed so that the user can set when the heating elements 34 or the fan 62 will operate. The thermostat 60 provides a thermally controlled environment within the shelter cavity 48. For example, if the temperature inside the shelter cavity 48 of the housing 16 drops to 35° F., then the thermostat 60 may be programmed to turn the electrical heating elements 34 on to warm the shelter cavity 48. If the temperature inside the shelter cavity 48 of the housing 16 rises to 85° F., then the thermostat may be programmed to turn the fan 62 on to cool the shelter cavity 48.

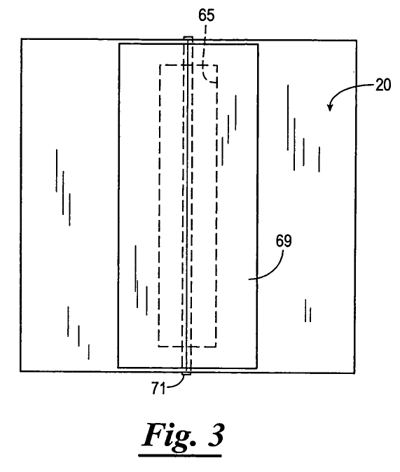

Referring to FIGS. 1-3, the roof 20 is supported on top of the housing 16 so as to cover the shelter cavity 48 and the temperature control compartment 18. The roof 20 is provided with a cutout 65 or vent opening to allow the circulation of air through the shelter cavity 48. The roof 20 is configured to fit snugly with the front wall 40, rear wall, first sidewall 42, and second sidewall 44 of the housing 16. The roof 20 is preferably formed from a polymeric material, such as a hard, rigid plastic. However, it should be understood that the roof may be constructed from any material such as wood, aluminum, metal, or the like. As shown, the roof 20 is formed as a single separate piece from the other components of the animal shelter 10. However, it should be understood that the roof 20 may be constructed from a variety of materials and can be formed of multiple components. As shown, one end of the roof 20 is pivotally connected to the housing 16 with a hinge 66 or other flexible joint. A latch 67 or other fastener is provided at the opposite end of the roof 20. The hinge 66 permits a user access to the shelter cavity 48 of the housing 16 so as to clean the shelter cavity 48 or allow the user access to an animal positioned within the shelter cavity 48. The user is also allowed access to the temperature control compartment 18 so as to replace, repair, or maintain the thermostat 60 and the fan 62. The hinge may also be connected to the temperature control compartment 18.

A vent 64 is positioned at the peak 68 of the pitch in the cutout 65 of the roof 20. Preferably, the vent 64 is a two-flap louvered vent. The vent 64 includes an outside louver 69 and an inside louver 70. The outside louver 69 functions to stop the inside louver 70 and prevents rain from entering the cutout 65 of the roof 20. A rod 71 is operably connected to the vent 64. For example, at least one loop 72 may be connected to the louvers 69 and 70 by a weld, adhesive, bolt or the like. The rod 71 is positioned beneath the roof 20 and through the at least one loop 72. The fan 62 is adapted to blow air up toward the vent 64 in the roof 20. When the fan 62 turns on, air is blown through the cutout 65 in the roof 20 which pushes the louvers 69 and 70 of the vent 64 up and thus the rod 71 up allowing circulation of air for the animal in the warmer months. The at least one loop 72 and rod 71 arrangement prevents the louvers 69 and 70 from detaching from the desired position on the roof 20. When the fan 62 turns off, the louvers 69 and 70 lay down against the roof 20 creating a water seal. It should be understood that though a two-flap louvered vent is described, any vent may be used in accordance with the present invention.

The power source 22 includes an electrical connector 74 and a conventional electrical outlet (not shown). The connector 74 is a conventional power cord. The connector 74 may be a male receptacle exiting the housing 16 wherein the connector 74 would plug directly into the outlet. It should be understood that the outlet may be indoor or outdoor. To protect chewing or gnawing animals from electrical shock, the connector 74 includes a protective outer casing, material, or sheath, such as a flexible metallic conduit. However, it should be understood that any protective material may be used to cover the connector 74. A spring (not shown) may be positioned to cover the connector 74 once it is placed into the outlet. Preferably, the outlet is a standard outdoor 220 volt plug-in having a ground fault interruptible (GFI) for the safety of the animal. An Underwriters Laboratory (UL) listed GFI receptacle may be specified as the only acceptable power source 22 for the heated animal shelter 10 as this will protect the animal in the event of chewing or gnawing into the connector 74. The animal shelter 10 may be positioned in front of the connector 74 in order to keep the animal from chewing on the connector 74 and the wiring. The connector 74 may be at least two feet long so that it can easily be stored behind the animal shelter 10, however, it should be understood that the connector 74 may be utilized having a cord of any length.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. An animal shelter, comprising:
a housing defining a shelter cavity therein, the shelter cavity sized to accommodate one or more animals, the housing having an opening therein permitting ingress and egress from the shelter cavity of the housing;
a heating compartment positioned within a portion of the housing so as to provide unrestricted access to the shelter cavity, the heating compartment sized and dimensioned to accommodate at least one heating element for heating the shelter cavity;
a cooling device positioned within a portion of the housing so as to provide unrestricted access to the shelter cavity, the cooling device for cooling the shelter cavity; and
a control device operably connected to the at least one heating element and the cooling device for selectively activating the at least one heating element or cooling device to provide a thermally controlled environment within the shelter cavity.

2. The animal shelter of claim 1 wherein a door is connected to the housing for closing the opening.

3. The animal shelter of claim 1 wherein, upon activation, the heating compartment provides a controlled heat to the shelter cavity of the housing.

4. The animal shelter of claim 1 wherein the heating element is wire.

5. The animal shelter of claim 1 wherein the cooling device is a fan.

6. The animal shelter of claim 1 wherein the control device is a thermostat.

7. The animal shelter of claim 1 further comprising:
a base member for providing a support surface for the housing, at least a portion of the heating compartment is disposed on the base member.

8. An animal shelter, comprising:
a housing defining a shelter cavity therein, the shelter cavity sized to accommodate one or more animals, the housing having an opening therein permitting ingress and egress from the shelter cavity of the housing;
a roof supported on the housing so as to cover the shelter cavity;
a heating compartment positioned within a portion of the housing so as to provide unrestricted access to the shelter cavity, the heating compartment sized and dimensioned to accommodate at least one heating element for heating the shelter cavity;
a cooling device positioned within a portion of the housing so as to provide unrestricted access to the shelter cavity, the cooling device for cooling the shelter cavity; and
a control device operably connected to the at least one heating element and the cooling device for selectively activating the at least one heating element or cooling device to provide a thermally controlled environment within the shelter cavity.

9. The animal shelter of claim 8 wherein a roof is pivotally connected to the housing so as to permit access to the shelter cavity of the housing.

10. The animal shelter of claim 8 wherein the roof is provided with a vent opening to allow the circulation of air through the shelter cavity.

11. The animal shelter of claim 10 wherein the vent opening of the roof is provided with a vent.

12. The animal shelter of claim 8 wherein a door is connected to the housing for closing the opening.

13. The animal shelter of claim 8 wherein, upon activation, the heating compartment provides a controlled heat to the shelter cavity of the housing.

14. The animal shelter of claim 8 wherein the heating element is wire.

15. The animal shelter of claim 8 wherein the cooling device is a fan.

16. The animal shelter of claim 8 wherein the control device is a thermostat.

17. The animal shelter of claim 8 further comprising:
a base member for providing a support surface for the housing, at least a portion of the heating compartment is disposed on the base member.
